(19) United States
(12) Patent Application Publication
(10) Pub. No.: US 2010/0186544 A1
(43) Pub. Date: Jul. 29, 2010

(54) Handlebar stem assembly

(76) Inventor: Rick Tsai, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/320,456

(22) Filed: Jan. 27, 2009

(51) Int. Cl. B62K 21/16

(52) U.S. Cl. 74/551.3

(57) ABSTRACT

A handlebar stem assembly includes a stem having a ridge axially on a top thereof and a sliding member is slidably mounted to the ridge and cooperates with a first end of the stem to define a handlebar hole in which the handlebar is secured. A passage is defined in a second end of the stem so as to be connected with the steerering tube of a front fork. A pivotable member is pivotably connected to the sliding member and urged between the sliding member and a portion of the stem. A spring is biased between the ridge and the sliding member. The sliding member can be moved toward second end of the stem to open the handlebar hole while the pivotable member is pivoted relative to the sliding member. The handlebar hole is partially closed by releasing the sliding member.

### FIELD OF THE INVENTION

The present invention relates to a handlebar stem assembly, and more particularly, to a handlebar stem assembly having a sliding member to open and partially close the handlebar hole.

### BACKGROUND OF THE INVENTION

A conventional handlebar is connected to the steerering tube of the front fork via a handlebar stem so that the rider can operate the handlebar to turn the front wheel of the bicycle.

Due to different riders' needs, the distance between the seat and the handlebar, and the angle that the handlebar orientates relative to the rider are different. Therefore, the handlebar stem actually affects the comfort of the riders when riding bicycles.

Generally, the handlebar stem includes a passage defined through a first end thereof so as to be connected with the steerering tube of the front fork, and a handlebar hole for being connected to the handlebar. The handlebar hole can be defined by a one-piece part of the stem or composed of two parts.

One of the handlebar stem known to applicant includes a passage for reception of the steerering tube of the front fork and a handlebar hole for receiving the handlebar. Two holes are defined through two lugs extending from the outside of the handlebar hole so as to clamp the handlebar in the handlebar hole.

The other handlebar stem known to applicant includes a passage for reception of the steerering tube of the front fork and a handlebar hole for receiving the handlebar. The handlebar hole is defined by a front part and a rear part, both of the front and rear parts includes slots. The passage is composed of a top collar and a lower collar, wherein a gap is defined between the top and lower collars. A bolt extends through two respective lugs on the top and lower collars to clamp the steerering tube.

The two conventional handlebar stems have to drill threaded holes in the limited area of the stem and the alignment of the threaded holes is crucial for securely fasten the handlebar and the steerering tube of the front fork. To precisely set the positions of the threaded holes requires certain level of manufacturing cost and time. Besides, the user has to use a tool to fasten the bolt to install or remove the handlebar.

The present invention intends to provide a handlebar stem assembly wherein the handlebar hole can be opened by a sliding member on the stem. The handlebar stem assembly of the present invention completely improves the drawbacks of the conventional handlebar stems.

### SUMMARY OF THE INVENTION

The present invention relates to a handlebar stem assembly which comprises a stem having a ridge axially on a top thereof and a sliding member is slidably mounted to the ridge and cooperates with a first end of the stem to define a handlebar hole. A pivotable member is pivotably connected to the sliding member and urged between the sliding member and a portion of the stem. A passage is defined in a second end of the stem. When installing or replacing the handlebar, the user simply pivoted the pivotable member and slides the sliding member to open the handlebar hole. The handlebar can be quickly and easily connected to or removed from the stem without using tools.

The primary object of the present invention is to provide a handlebar stem assembly wherein the handlebar hole can be controlled by a sliding member without using a tool.

Another object of the present invention is to provide a handlebar stem assembly wherein the sliding member can be slid along the ridge on the stem by pivoting a pivotable member next to the sliding member.

Yet another object of the present invention is to provide a handlebar stem assembly wherein the handlebar can be fastened by using a positioning unit which includes a positioning bolt and a positioning plate.

A further object of the present invention is to provide a handlebar stem assembly wherein there is not alignment problem when manufacturing the handlebar stem assembly.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the handlebar stem assembly of the present invention;

FIG. 2 shows that the handlebar stem assembly of the present invention is connected between a handlebar and a steerering tube;

FIG. 3 is an exploded view to show the handlebar stem assembly of the present invention;

FIG. 4 is a perspective view to show the sliding member of the present invention;

FIG. 5 is a side cross sectional view of the sliding member of the present invention;

FIG. 6 is an end cross sectional view to show the connection of the ridge and the sliding member;

FIG. 7 shows that the pivotable member is pivoted upward, and

FIG. 8 shows that the sliding member is slid when the pivotable member is pivoted upward.

### DETAILED DESCRIPTION OF THE PREFERRED EMBODIMENT

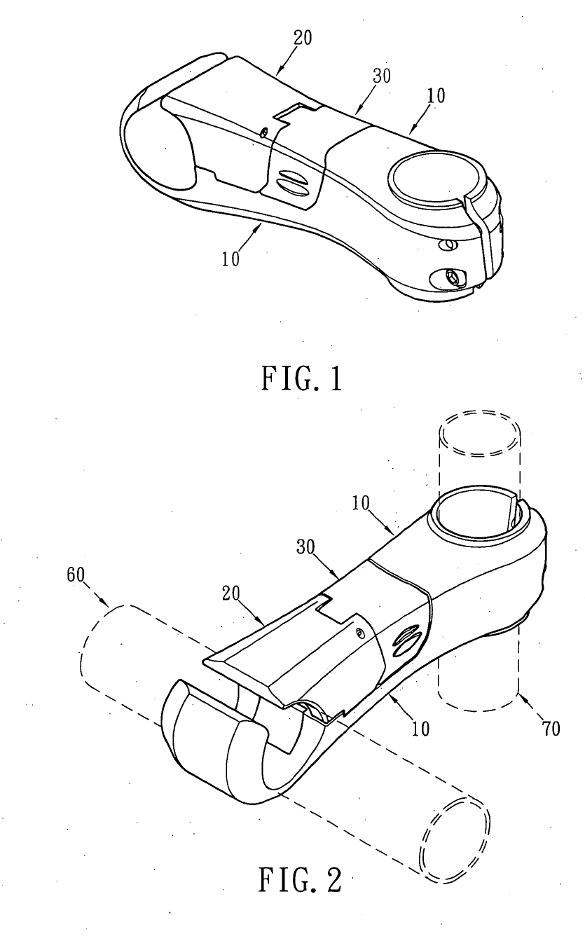

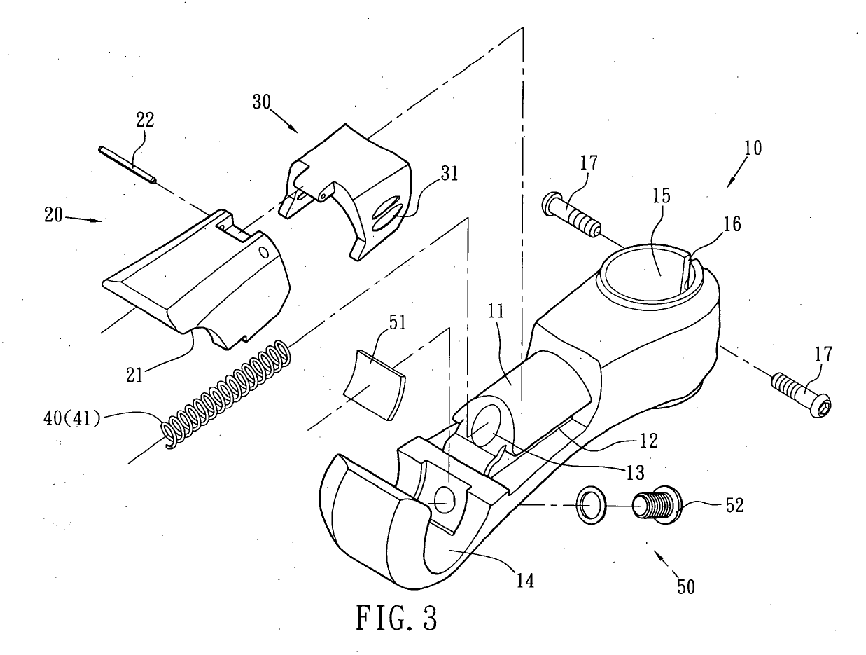

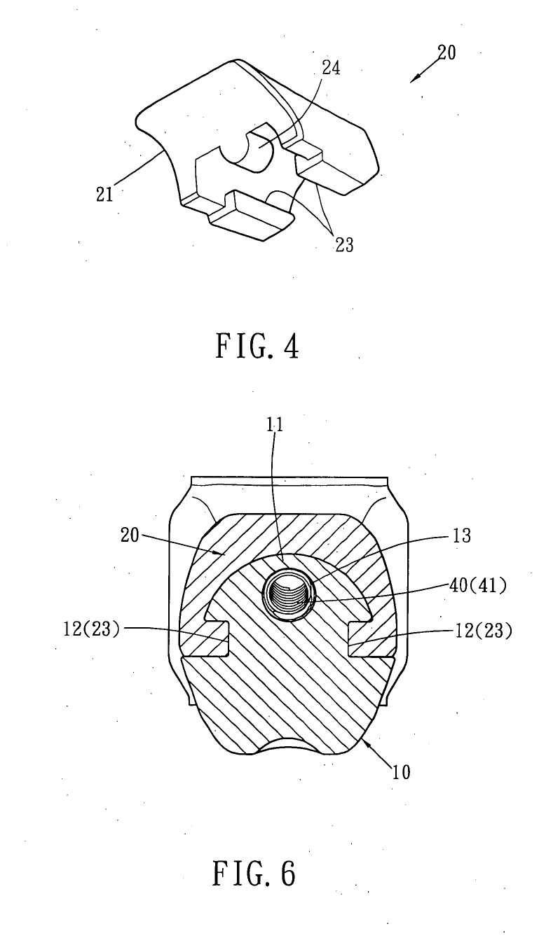

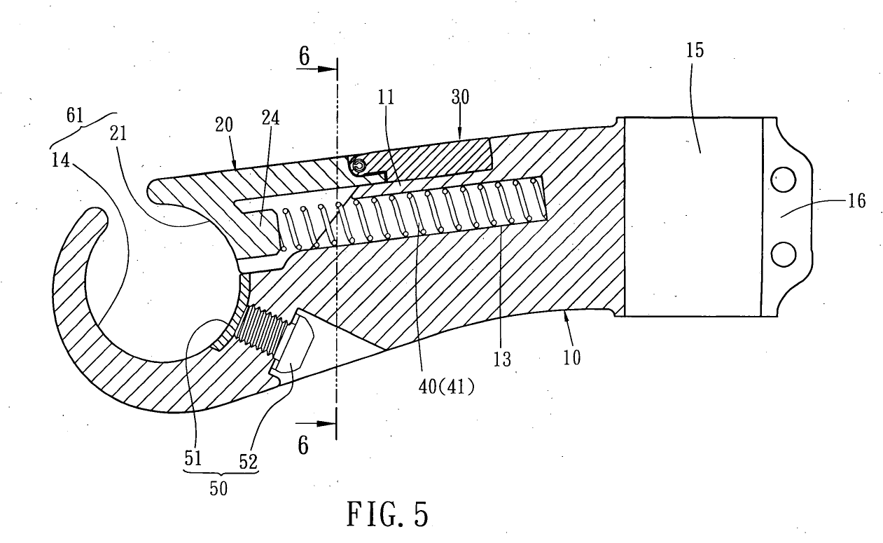

Referring to FIGS. 1 to 6, the handlebar stem assembly of the present invention comprises an elongate stem 10 having a ridge 11 axially located on a top thereof and two parallel grooves 12 are defined in two sides of the ridge 11. A hole 13 is defined in a distal end of the ridge 11. A first recess 14 defined in the first end of the stem 10 and a passage 15 is defined in a second end of the stem 10. A slit 16 is axially defined through a wall of the passage 15 and the steerering tube 70 of a front fork extends through the passage 15. Two bolts 17 extend through two ends of the slit 16 and narrow the passage 15 to securely clamp the steerering tube 70.

A sliding member 20 is slidably mounted to the ridge 11 and includes two side rails 23 which are slidably engaged with the grooves 12. The sliding member 20 includes a second recess 21 defined in a first end thereof and the second recess 21 is cooperated with the first recess 14 to define a handlebar hole 61. A handlebar 60 is engaged with the handlebar hole 61. The sliding member 20 further includes a protrusion 24 which is located corresponding to the hole 13.

A pivotable member 30 has a first end pivotably connected to a second end of the sliding member 20 by a pin 22, so that the pivotable member 30 is pivotable upward relative to the second end of the sliding member 20.

A resilient unit 40 is biased between the base 10 and the sliding member 20. In this embodiment, the resilient unit 40 is a spring 41 which has a first end contacting an inner end of the hole 13 and a second end of the spring 41 contacts the protrusion 24. The spring 41 provides a force to push the sliding member 20 toward the handlebar hole 61. The pivotable member 30 is then urged between the sliding member 20 and a portion of the stem 10. The pivotable member 30 includes serration surface 31 on two outsides thereof such that the user can conveniently hold the pivotable member 30 and pivot the pivotable member 30.

A positioning unit 50 is connected to the handlebar hole 60 so as to secure the handlebar 60 in the handlebar hole 60. The positioning unit 50 includes a positioning plate 51 and a positioning bolt 52, the positioning plate 61 is located within the handlebar hole 60 and the positioning bolt 62 pushes the positioning plate 61 to secure the handlebar 60.

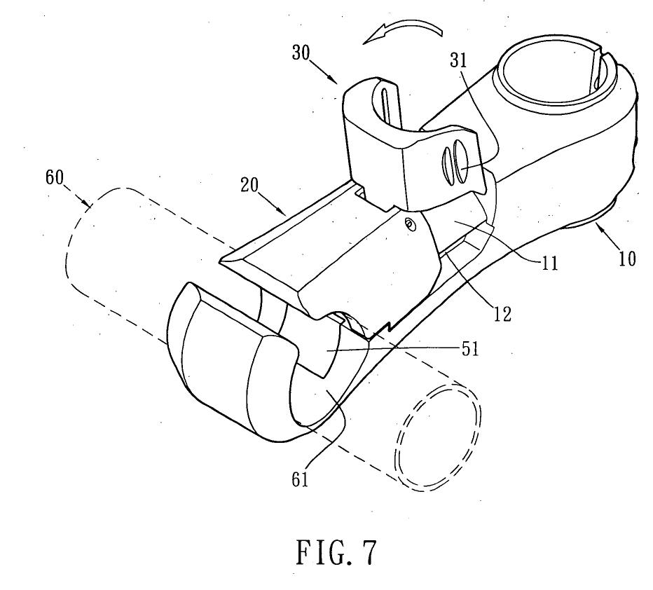

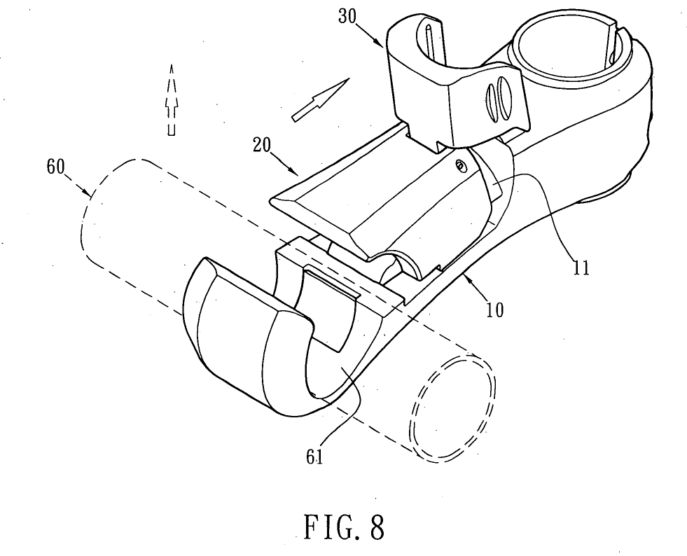

As shown in FIGS. 7 and 8, when installing the handlebar 60 to the handlebar stem 10 or removing the handlebar 60 from the handlebar stem 10, the pivotable member 30 is first pivoted upward relative to the sliding member 20, the sliding member 20 is then slid toward the steerering tube 70. By this movement, the handlebar hole 61 is opened and the handlebar 60 can be easily inserted into the handlebar hole 61 or removed from the handlebar hole 61.

When the handlebar 60 is installed to the handlebar hole 61, the sliding member 20 is released and the spring 41 pushes the sliding member 20 to partially close the handlebar hole 61. The pivotable member 30 is then pivoted downward and positioned between the sliding member 20 and the stepped portion of the stem 10. The ridge 11 is covered by the pivotable member 30. The user then rotates the positioning bolt 52 to secure the handlebar 60.

The sliding member 20 is easily operated by pivoting the pivotable member 30 and then pulling the sliding member 20 toward the steerering tube 70. After the handlebar 60 is installed, the spring 41 pushes the sliding member 20 to partially close the handlebar hole 61 by releasing the sliding member 20. During installing the handlebar 60 into the handlebar hole 61, the user does not need to unscrew any bolt and there is no need to align threaded holes in the first end of the stem 10. The manufacturing process for the handlebar stem assembly can be simplified.

While we have shown and described the embodiment in accordance with the present invention, it should be clear to those skilled in the art that further embodiments may be made without departing from the scope of the present invention.

What is claimed is:

1. A handlebar stem assembly comprising:
a stem having a ridge axially on a top thereof;
a sliding member slidably mounted to the ridge and cooperating with a first end of the stem to define a handlebar hole;
a pivotable member pivotably connected to the sliding member and urged between the sliding member and a portion of the stem, and
a passage defined in a second end of the stem.

2. The assembly as claimed in claim 1, wherein a first recess defined in the first end of the stem and the sliding member includes a second recess defined in a first end thereof, the handlebar hole is defined by the first and second recesses.

3. The assembly as claimed in claim 2, wherein a slit is axially defined through a wall of the passage and at least one bolt extends through two ends of the slit.

4. The assembly as claimed in claim 1, wherein two parallel grooves are defined in two sides of the ridge and the sliding member includes two side rails which are slidably engaged with the grooves.

5. The assembly as claimed in claim 1 further comprising a resilient unit which is biased between the base and the sliding member.

6. The assembly as claimed in claim 5, wherein the ridge includes a hole and the sliding member includes a protrusion which is located corresponding to the hole, the resilient unit is a spring which has a first end contacting an inner end of the hole and a second end of the spring contacts the protrusion.

7. The assembly as claimed in claim 2, wherein the pivotable member is pivotably connected to a second end of the sliding member by a pin.

8. The assembly as claimed in claim 1, Wherein the pivotable member includes serration surface on two outsides thereof.

9. The assembly as claimed in claim 1 further comprising a positioning unit connected to the handlebar hole and is adapted to secure a handlebar in the handlebar hole.

10. The assembly as claimed in claim 9, wherein the positioning unit includes a positioning plate and a positioning bolt, the positioning plate is located within the handlebar hole and the positioning bolt pushes the positioning plate.
